(19) United States
(12) Patent Application Publication
(10) Pub. No.: US 2018/0058837 A1
(43) Pub. Date: Mar. 1, 2018

(54) USER INTERFACE INCORPORATING STRAIN GAUGES

(71) Applicant: Knowles Electronics, LLC, Itasca, IL (US)

(72) Inventors: Shandor Dektor, Itasca, IL (US); Andrew Unruh, San Jose, CA (US); Asad Ali, Itasca, IL (US); Tony Verma, Itasca, IL (US)

(73) Assignee: Knowles Electronics, LLC, Itasca, IL (US)

(21) Appl. No.: 15/671,983

(22) Filed: Aug. 8, 2017

Related U.S. Application Data
(60) Provisional application No. 62/379,133, filed on Aug. 24, 2016.

(51) Int. Cl. G01B 7/16; G01B 7/00

(52) U.S. Cl. CPC G01B 7/16; G01B 7/003

(57) ABSTRACT

A device includes a substrate, strain gauges, and a controller coupled to the strain gauges. The substrate has a front surface and an opposing rear surface, the front surface including a button representation and the rear surface including a button area corresponding to the button representation. The strain gauges are mounted on the rear surface in proximity to the button area. The controller receives information indicating multiple electrical signal amplitudes, each of the electrical signal amplitudes corresponding to one strain gauge of the plurality of strain gauges, each electrical signal amplitude representing an amount of deformation of the corresponding strain gauge. The controller estimates a location of a pressure applied and/or the magnitude of force applied on the front surface of the substrate based on the received information. The controller also can receive location information of multiple user presses from a separate set of sensors.

### CROSS-REFERENCE TO RELATED APPLICATIONS

The present application claims priority to U.S. Provisional Patent Application No. 62/379,133 filed Aug. 24, 2016, the contents of which are incorporated herein by reference in their entirety.

### BACKGROUND

The following description is provided to assist the understanding of the reader. None of the information provided or references cited is admitted to be prior art.

Electronic devices and machines include user interfaces for receiving user input and for providing outputs. For example, user input can be received using mechanical and/or electronic buttons mounted on a surface of the device. In some cases, a surface on which the buttons are mounted can be cut out to accommodate mounting of the buttons and to connect the buttons to electronic components within the device.

### SUMMARY

In one or more embodiments, a device includes a substrate, strain gauges, and a controller coupled to the strain gauges. The substrate has a front surface and an opposing rear surface, the front surface including a button representation and the rear surface including a button area corresponding to the button representation. The strain gauges are mounted on the rear surface in proximity to the button area. The controller receives information indicating multiple electrical signal amplitudes, each of the electrical signal amplitudes corresponding to one strain gauge of the plurality of strain gauges, each electrical signal amplitude representing an amount of deformation of the corresponding strain gauge. The control further estimates a location of a pressure applied on the front surface of the substrate based on the received information.

In one or more embodiments, a device includes a substrate, a ring, a strain gauge, and a controller. The substrate has a front surface and an opposing rear surface, the front surface including a button representation and the rear surface including a button area corresponding to the button representation. The ring is mounted on the rear surface in proximity to the button area, an inner periphery of the ring defining an isolated area on the rear surface. The strain gauge is mounted on the isolated area on the rear surface. The controller is coupled to the strain gauge, and the controller receives information indicating an amplitude of an electrical signal corresponding to the strain gauge, and identifies a valid user input based on the received information.

In one or more embodiments, a device includes a substrate, an arrangement of strain gauges, and a controller coupled to the arrangement of strain gauges. The substrate has a front surface and an opposing rear surface, the front surface including a plurality of button representations. The arrangement of strain gauges is mounted on the rear surface. The controller receives information representing a plurality of amplitude values, each amplitude value representing an amplitude of an electrical signal associated with a strain gauge of the arrangement of strain gauges. The controller further estimates a force magnitude and a location of a pressure on the front surface of the substrate based on the received information.

In one or more embodiments, a device includes a substrate having a front surface and an opposing rear surface, the front surface including one or more button representations, a strain gauge mounted on the rear surface, and a controller coupled to the strain gauge. The controller receives information representing an amplitude value which in turn represents an amplitude of an electrical signal associated with the strain gauge. The controller estimates a location of a pressure on the front surface of the substrate based on the received information.

In one or more embodiments, a device includes a substrate, an arrangement of strain gauges, an arrangement of location sensors, and a controller coupled to the arrangement of strain gauges and the arrangement of location sensors. The substrate has a front surface and an opposing rear surface, the front surface including a plurality of button representations. The arrangement of strain gauges is mounted on the rear surface of the substrate. The arrangement of location sensors is mounted on the substrate. The controller receives first information representing a first plurality of amplitude values, each amplitude value representing an amplitude of an electrical signal associated with a strain gauge of the arrangement of strain gauges. The controller further receives second information representing a second plurality of amplitude values, each amplitude value representing an amplitude of an electrical signal associated with a location sensor of the arrangement of location sensors. The controller estimates locations of a plurality of pressures applied to the front surface of the substrate based on the received second information. The controller also estimates force magnitudes of the plurality of pressures at the estimated locations based on the received first information.

The foregoing summary is illustrative and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1A depicts a front view of an example of an electrical appliance incorporating an example touch sensitive user interface in accordance with various implementations.

FIG. 1B depicts a portion of an example of a touch sensitive user interface in accordance with various implementations.

FIG. 1C depicts a cross-sectional view of a portion of the user interface shown in FIG. 1B in accordance with various implementations.

FIG. 2A shows a representation of an example computing system utilized to implement a touch sensitive user interface in accordance with various implementations.

FIG. 2B shows a representation of an example signal acquisition and conditioning module connected to a strain gauge sensor in accordance with various implementations.

FIG. 3A illustrates an example arrangement of strain gauges that can be utilized in a touch sensitive user interface in accordance with various implementations.

FIG. 3B illustrates an example arrangement of strain gauges that can be utilized in a touch sensitive user interface in accordance with various implementations.

FIG. 4 illustrates an example arrangement of a strain gauge sensor that can be utilized in a touch sensitive user interface in accordance with various implementations.

FIG. 5 illustrates an example arrangement of strain gauges that can be utilized in a touch sensitive user interface in accordance with various implementations.

FIG. 6 illustrates an example arrangement of strain gauges that can be utilized in a touch sensitive user interface in accordance with various implementations.

FIG. 7A illustrates an example arrangement of strain gauges that can be utilized in a touch sensitive user interface in accordance with various implementations.

FIG. 7B is a graphical representation of examples of electrical signals associated with the strain gauges shown in FIG. 7A in accordance with various implementations.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

### DETAILED DESCRIPTION

The present disclosure describes devices and techniques using strain gauges for user input. In one or more embodiments, a user interface is incorporated onto a substrate such as stainless steel used in appliances and devices. In particular, button representations are provided on a surface of a substrate facing the user, and one or more strain gauges are mounted on a rear surface opposing the front facing surface of the substrate. Pressing on a button representation causes deformation of the substrate and a corresponding deformation of one or more strain gauges associated with the button representation. Electrical signals corresponding to the deformation of the strain gauge(s) are measured and processed to estimate a position of the deformation, and from the estimated position, identify an intended user input.

The term substrate as used herein refers to a semi-rigid material which allows for deformation sufficient to detect the deformation by way of a strain gauge.

Button representations may be provided, for example, by painting, printing, inscribing or etching the substrate, or by painting, printing, inscribing or etching a material which is then attached (e.g., by gluing) to the substrate, or a combination thereof. Such a material may be, for example, a film; and the film may be, but is not necessarily, a transparent or translucent film. Although button representations may be described herein with respect to visible markings, it is to be understood that button representations may be imaginary, in that there are not visible markings. For example, the devices and techniques of the present disclosure may be implemented as a two-dimensional surface or a three-dimensional surface or sets of surfaces which are used as touch screens.

In one or more embodiments, strain gauges are mounted in and around button areas defined on the substrate. Button press criteria can be established to classify identified presses on the substrate as valid user inputs.

In one or more embodiments, an isolating ring is mounted on the rear surface of the substrate surrounding one or more strain gauges. The isolating ring isolates the strain gauges from deformations that are outside of the button areas, thereby reducing a risk of an unintended substrate deformation being interpreted as a valid user input. In one or more embodiments, a ring of strain gauges is positioned around a button area, to identify from electrical signals that a deformation has occurred at the ring of strain gauges or outside the ring of strain gauges, thereby reducing a risk of an unintended substrate deformation being interpreted as a valid user input.

In one or more embodiments, multiple individual strain gauges are mounted on the rear surface of the substrate, arranged in a grid (or a pre-assembled grid of strain gauges is mounted on the rear surface of the substrate). A user press at a button representation on the front surface of the substrate is sensed by the grid of strain gauges. Amplitudes of electrical signals associated with the grid of strain gauges are used to determine an estimate of the location of the user press. The amplitude of an electrical signal can refer to a value (positive or negative) of the electrical signal measured in reference to a baseline value (e.g., 0) or an offset value. In one or more embodiments, the amplitude of the electrical signal can refer to a peak amplitude, a peak-to-peak amplitude, a mean amplitude, or a root-mean-square amplitude. The electrical signal can be a voltage or a current. The estimated location of the user press is mapped to a known location of one or more button representations on the front surface of the substrate to identify an intended user input.

In one or more embodiments, the user interface can determine both a magnitude of force and the estimated location associated with a user press on the front surface of the substrate. Electrical signals associated with a grid of strain gauges on the rear surface of the substrate are compared to a strain gauge model of the substrate to estimate the location and force of the user press. In this manner, a combination of the force and the location of the user press is used to identify an intended user input.

In one or more embodiments, force magnitudes and estimated locations of multiple simultaneous user presses are determined from electrical signals associated with a grid of strain gauges mounted on the rear surface of the substrate. In one or more embodiments, the electrical signals are compared to a model of the substrate to determine the force magnitude and the estimated location of the multiple user presses on the substrate. In one or more embodiments, sensors different from and in addition to the strain gauges are used to estimate the locations of the multiple user presses, while electrical signals from the grid of strain gauges are used to determine the magnitudes of forces associated with the multiple user presses.

In one or more embodiments, the user interface includes multiple strain gauges to implement a slider input defined by a button area on the rear surface of the substrate that corresponds to a slider button representation on the front surface of the substrate. Electrical signals from the strain gauges are processed to not only determine a force magnitude of the user press, but also to determine an extent to which the user slides the user press over a length of the slider button representation.

These and other embodiments are described in more detail in the following.

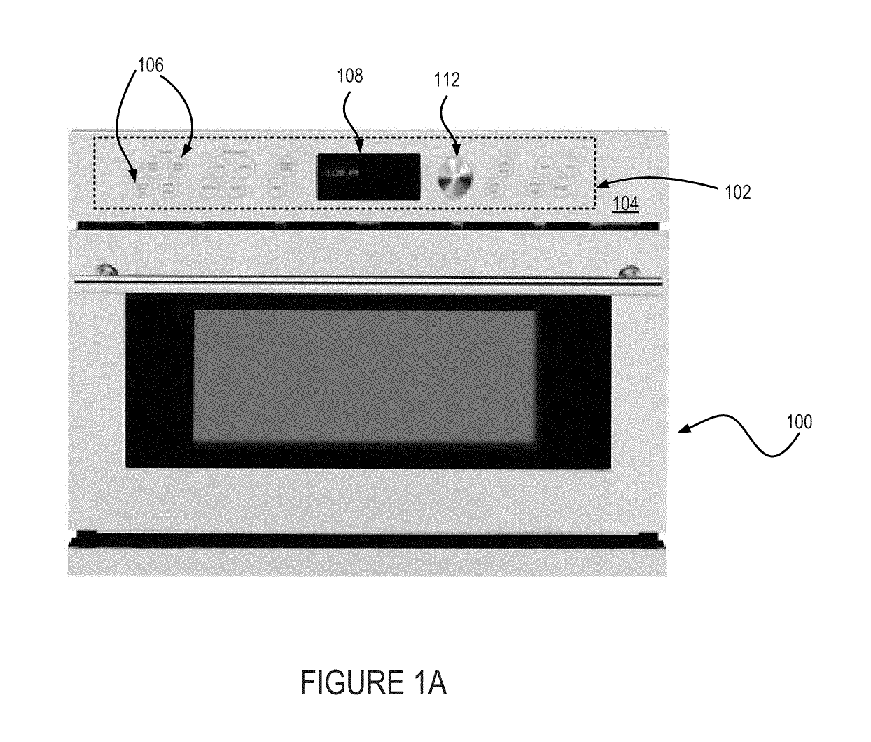

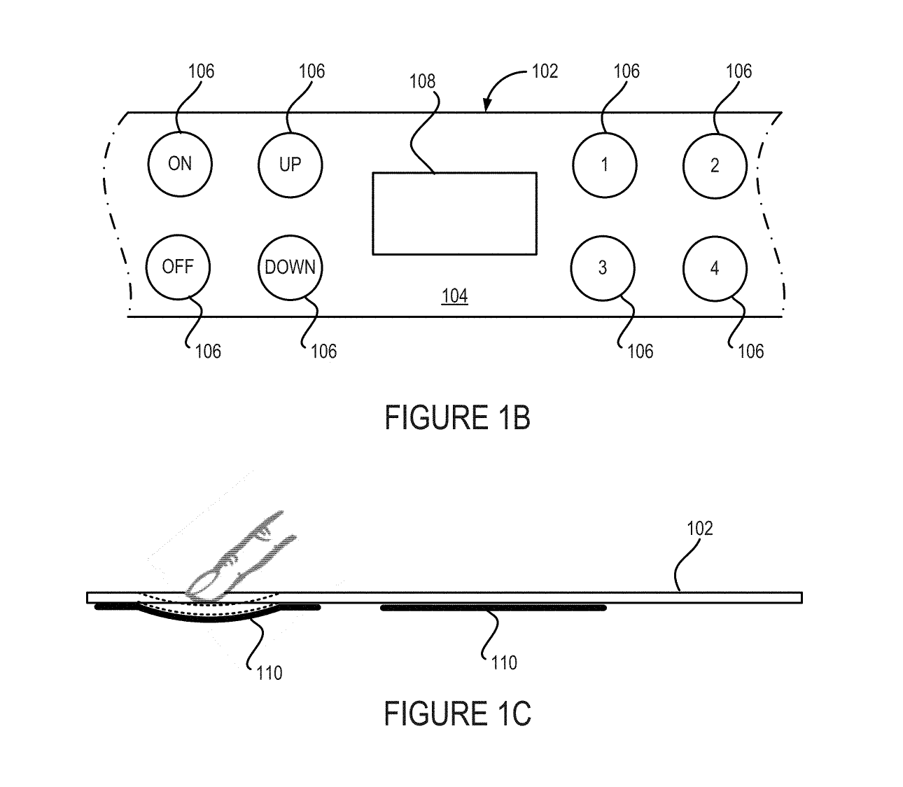

FIG. 1A depicts a front view of an example of an electrical appliance 100 incorporating an example touch sensitive user interface 102 according to an embodiment of the present disclosure. The touch sensitive user interface 102 is located on or behind, or is a portion of, a face plate 104 of the electrical appliance 100. The face plate 104 may be, for example, a planar substrate with one side facing outside the electrical appliance 100.

The touch sensitive user interface 102 includes several button representations 106, a display area 108 and a knob 112. The button representations 106 and the knob 112 can be used to provide input to the electrical appliance 100, while the display area 108 can display various forms of information to the user. The button representations 106 are touch sensitive buttons, which allow the user to provide input by way of touching and/or pressing on the surface of the touch sensitive user interface 102 at or near the button representations 106.

It is to be understood that the touch sensitive user interface 102 is provided by way of non-limiting example for discussion purposes, and other designs are encompassed by the present disclosure. Further, it is to be understood that the knob 112 is optional, or more knobs 112 may be incorporated, and the display area 108 is optional, and if present may take many different forms, such as, for example, a liquid crystal display, a light emitting diode display, an organic light emitting diode display, or a micro-electromechanical based display. More generally, the touch sensitive user interface 102 is configured as appropriate for the intended implementation. For example, the electrical appliance 100 shown in FIG. 1A is an electrical oven/range; however, the touch sensitive user interface 102 could be used in other electrical appliances and devices such as refrigerators, dishwashers, washing/drying machines, toasters, grills, computers, televisions, audio/visual components, remote controllers, and so forth, each of which may have a different design.

In some embodiments, mechanical or capacitive type buttons can be incorporated, where holes are cut into the touch sensitive user interface 102 to install these buttons. However, the holes can be unsightly and the buttons can hinder effective cleaning. Even further, some capacitive type buttons, which are sensitive primarily to human skin, may not register an input if the user is wearing gloves or mitts, or if the user's hands are dirty. Thus, the touch sensitive user interface 102, which uses the faceplate itself as surface for user input, allows avoidance of such buttons. Button representations 106 are provided on the front surface of the touch sensitive user interface 102, and a user can press on the desired button representation to provide an input. Strain gauges disposed on a rear surface of the touch sensitive user interface 102 behind the button representations 106 can sense deformation in the touch sensitive user interface 102 caused by the user pressing on the touch sensitive user interface 102. The deformation sensed by the strain gauges can be processed and potentially identified as an intended user input.

FIG. 1B depicts an enlarged view of a portion of a touch sensitive user interface similar to the touch sensitive user interface 102 shown in FIG. 1A, and numbering from FIG. 1A is used in FIG. 1B for features similar to those in FIG. 1A. In particular, FIG. 1B shows the front surface of the touch sensitive user interface 102 on which the button representations 106 are provided. The button representations 106 can signify various inputs provided by the touch sensitive user interface 102. A user can provide input to the touch sensitive user interface 102 by pressing on a button representation 106.

FIG. 1C depicts a cross-sectional view of a portion of the touch sensitive user interface 102 shown in FIG. 1A or 1B. In particular, FIG. 1C depicts deformation of the touch sensitive user interface 102 in response to a user pressing on a button representation 106 provided on the front surface of the touch sensitive user interface 102. In addition, FIG. 1C shows strain gauges 110 mounted on the rear surface of the touch sensitive user interface 102. The strain gauges 110 can be mounted on the rear surface using an adhesive, such as epoxy, ceramic cement, cellulose nitrate cement, and so forth. The strain gauges 110 are positioned on the rear surface such that the deformation of the touch sensitive user interface 102 at or near a button representation 106 also causes a deformation in one or more strain gauges 110.

In one or more embodiments, one or more of the strain gauges 110 can be a resistance type strain gauge, where the deformation of the strain gauge 110 causes a change in an electrical resistance of the strain gauge 110. In one or more such embodiments, the strain gauge 110 can include metals, metal alloys (such as constantan, isoelastic, Karma, or platinum based alloys), or any other material that exhibits change in its resistance as a result of deformation. In one or more embodiments, a semiconductor type strain gauge, which provides high sensitivity, can be used to implement one or more of the strain gauges 110. In one or more embodiments, a nanoparticle based strain gauge, which includes an assembly of conductive nanoparticles of materials such as gold or carbon, can be used to implement one or more of the strain gauges 110. In one or more embodiments, a microelectromechanical systems (MEMS) based strain gauge can be used to implement one or more of the strain gauges 110. In one or more embodiments, a capacitive type strain gauge, where deformation causes a change in capacitance of the strain gauge, can be used to implement one or more of the strain gauges 110. It is to be understood that, in implementations in which the touch sensitive user interface 102 incorporates multiple strain gauges 110, the strain gauges may be of the same type, or may include different types. For example, one type of strain gauge may be more suited for implementing slider button capability, while another type of strain gauge may be more suited for implementing a push button capability, while yet a further type of strain gauge may be more suited for implementing a variable force magnitude button capability.

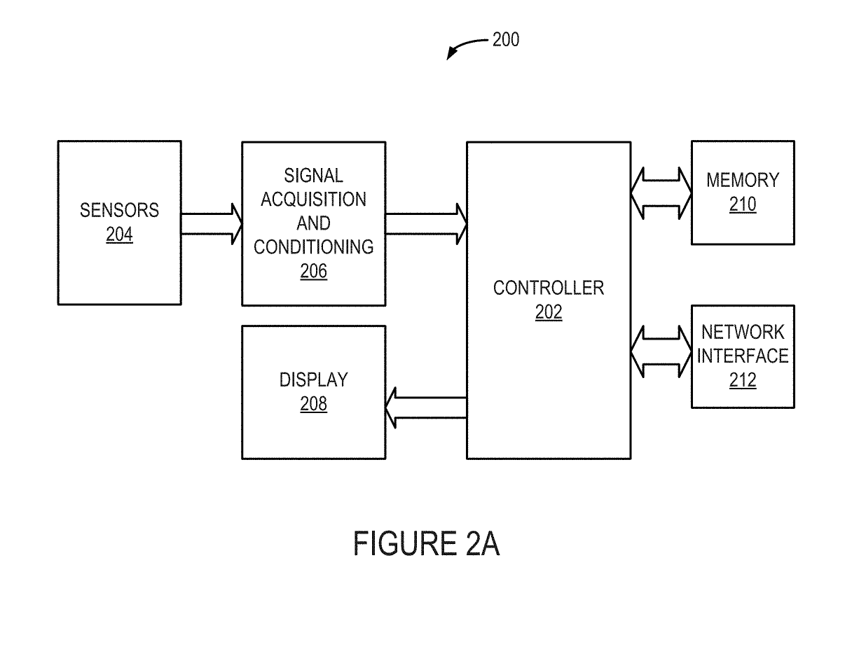

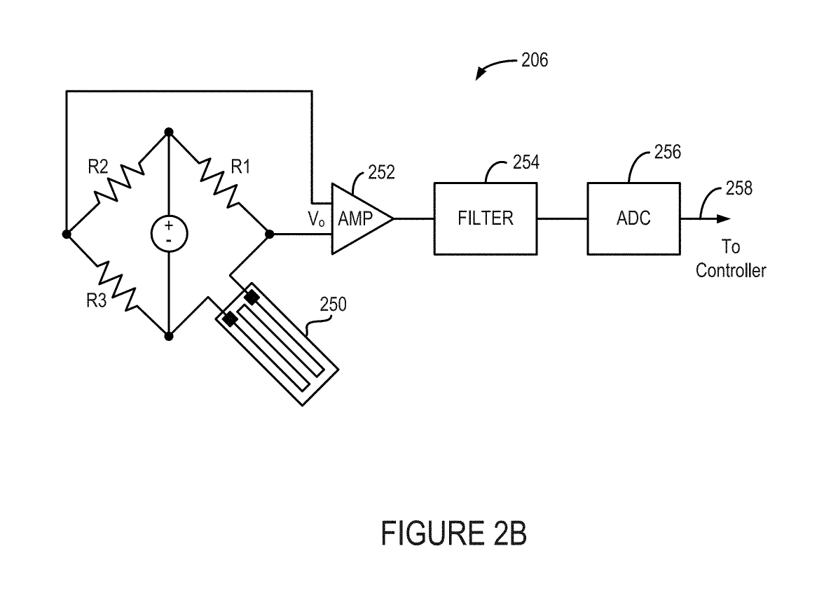

FIG. 2A shows a representation of an example computing system 200 used to implement a touch sensitive user interface (e.g., the touch sensitive user interface 102 shown in FIG. 1A). The computing system 200 includes a controller 202, a sensor module 204, a signal acquisition and conditioning module 206, a display module 208, a memory module 210, and a network interface module 212. The sensor module can include various sensors, such as the strain gauges 110 discussed above. The signal acquisition and conditioning module 206 acquires signals from the sensors and conditions the signals prior to providing them to the controller 202. In one or more embodiments, the signal acquisition and conditioning module 206 can include circuitry such as amplifiers, filters, level shifters, and analog to digital converters. The controller 202 may be any logic circuitry that processes instructions, for example, instructions fetched from the memory module 210 or an internal memory cache. In one or more embodiments, the controller 202 can be a microprocessor, a multi-core processor, a microcontroller, or other control device. In one or more embodiments, the microcontroller can be implemented as an integrated circuit, an application specific integrated circuit, a field programmable gate array, or in another form. In one or more embodiments, the controller 202 can be dedicated to the functioning of the touch sensitive user interface 102. In some such embodiments, the controller 202 can interface with one or more devices or controllers that control the electrical appliance 100 coupled to the touch sensitive user interface 102. In one or more embodiments, the controller 202 can control the functionality of the user interface and one or more components of the electrical appliance 100.

The memory module 210 can be any device suitable for storing computer readable data, which can include instructions that can be executed by the controller 202. In one or more embodiments, the memory module 210 can be a device with fixed storage or a device for reading removable storage media such as a flash drive. In one or more embodiments, the memory module 210 can include a secondary memory (e.g., a cache memory) for high speed data transfer with the controller 202. Examples of the memory module 210 include all forms of non-volatile memory, media and memory devices, including but not limited to semiconductor memory devices such as EPROM, EEPROM, SDRAM, and flash memory, magnetic disks, magneto optical disks, and optical disks such as CD-ROM, DVD-ROM, and Blu-Ray® discs. In one or more embodiments, the computing system 200 can include more than one memory module 210 depending on a desired capacity.

The network interface module 212 manages data exchange between the controller 202 and one or more networks. In one or more embodiments, the network interface module 212 can include physical ports, such as an Ethernet port, to which a network cable can be connected. In one or more embodiments, the network interface module 212 can include one or more controllers that can implement one or more network layers, such as a physical layer, data link layer, or other layer of a network protocol. In one or more embodiments, the network interface module 212 provides connectivity to networks such as the Internet, Ethernet, Wi-Fi, Bluetooth, WiMAX, 3G LTE, and/or 4G LTE.

FIG. 2B shows a representation of an example signal acquisition and conditioning module 206 connected to a strain gauge sensor 250 (e.g., an example of a sensor 204 shown in FIG. 2A). The signal acquisition and conditioning module 206 includes a bridge circuit including resistors R1, R2, R3 and the strain gauge 250, an amplifier 252 connected to an output of the bridge circuit, a filter 254, and an analog-to-digital converter (ADC) 256. The strain gauge 250 can be used, for example, to implement one of the strain gauges 110 shown in FIG. 1C. The bridge circuit is typically balanced by selecting resistors R1, R2, and R3 to be equal to a nominal value of a variable resistance R_{G} of the strain gauge 250. Under balanced conditions, that is, when there is no strain on the strain gauge 250, an output voltage V_{O} of the bridge circuit is approximately 0 V. In some embodiments, the resistors R1, R2, and R3 of the bridge circuit are selected so that, at the nominal value of the resistance R_{G}, the output voltage V_{O} of the bridge circuit has an offset (e.g., is less than or greater than 0 V). In some embodiments, the nominal value of the resistance R_{G} of the strain gauge 250 represents the resistance R_{G} when a predefined amount of stress is applied to the strain gauge 250 (e.g., for implementations in which the strain gauge 250 is designed to be in a stressed condition prior to deformation caused by user input). In one or more embodiments, resistance values of the resistors R1, R2, and R3 and strain gauge 250 can be calibrated after installation to achieve a desired output voltage V_{O} of the bridge circuit at the nominal value of the resistance R_{G}.

When the strain gauge 250 is deformed, such as when a user presses a button representation on a touch sensitive user interface (e.g., one of the button representations 106 of the touch sensitive user interface 102 in FIG. 1B) corresponding to the strain gauge 250, the deformation causes the resistance R_{G} of the strain gauge to change. The change in the resistance R_{G} of the strain gauge 250 unbalances the bridge circuit, which in turn results in a change in the voltage V_{O} at the output of the bridge circuit.

The amplifier 252 amplifies the voltage V_{O} at the output of the bridge circuit, and provides the amplified voltage to the filter 254. The amplifier 252 can be, for example, a high gain amplifier having high input impedance. In one or more embodiments, the amplifier 252 can be implemented using an instrumental amplifier or an operational amplifier. In one or more implementations, the amplifier 252 can be implemented using discrete components, integrated circuits, or a combination of discrete components and integrated circuits.

The filter 254 filters the amplified output voltage provided by the amplifier 252. The filter 254 is, for example, a low pass filter with a cut-off frequency that is sufficient to suppress undesirable noise from the amplified voltage signal. The filtered output voltage can be digitized using the ADC 256. In one or more embodiments, the ADC 256 can be implemented by a flash ADC, a successive-approximation ADC, a sigma-delta ADC, or a ramp-compare ADC. A digital voltage output 258 of the ADC 256 is provided to a controller, such as the controller 202 shown in FIG. 2A.

In one or more embodiments, the signal acquisition and conditioning module 206 may also include a level shifter circuit to shift a DC level of the output of the amplifier to a desired level for ease of filtering and digitization. In one or more embodiments, the controller 202 includes ADCs and the output of the filter 254 can be directly provided to the controller 202 such that the ADC 256 may be omitted. The signal acquisition and conditioning module 206 can sense the output of each strain gauge in the touch sensitive user interface. In one or more embodiments, the signal acquisition and conditioning module 206 can include temperature compensating circuits that can mitigate effects of temperature change on the bridge circuit and other components.

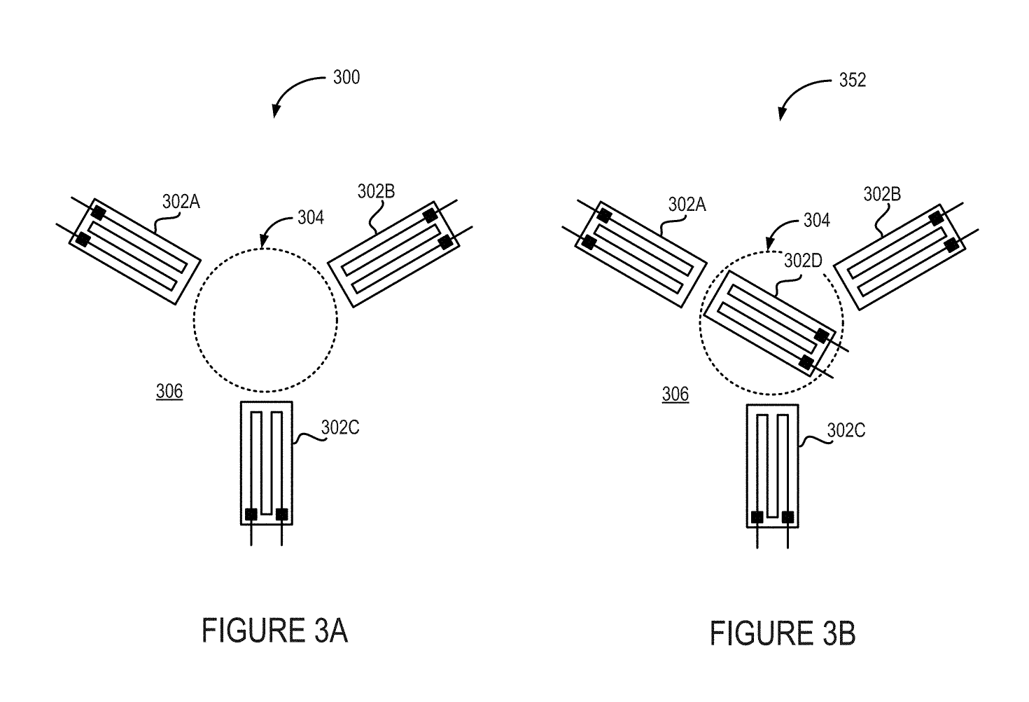

FIG. 3A illustrates a plan view of an example arrangement 300 of strain gauges in a user interface. In particular, the example arrangement 300 includes three strain gauges 302A, 302B, and 302C (collectively referred to hereinafter as “the strain gauges 302”) placed along a perimeter of a substantially circular button area 304 on a rear surface of a substrate 306 (e.g., the rear surface of the touch sensitive interface 102 of FIGS. 1A-1C). The strain gauges 302 can be similar to the strain gauges 110 and 250 discussed above in relation to FIGS. 1B-2B. The button area 304 is shown in broken lines to indicate that it corresponds to an area on a user facing side (a front surface) of the substrate 306 that is opposing to the side (the rear surface) on which the strain gauges 302 are mounted. The button area 304 may correspond directly to a button representation on the front surface of the substrate 306, or may correspond to an area that overlaps one or more button representations on the front surface of the substrate 306. In one or more embodiments, the button area 304 is smaller than a corresponding button representation, and in other embodiments, the button area 304 is larger than a corresponding button representation. The strain gauges 302 are arranged in a manner such that their longitudinal axes extend substantially toward a center of the button area 304. When a user presses on the front surface of the substrate 306 at or near an area corresponding to the button area 304, the substrate 306 is deformed in a direction that is normal to the plane of the substrate 306. The deformation of the substrate 306 causes corresponding deformation and a resulting increase in strain in each of the strain gauges 302, thereby changing their effective resistance.

In one or more embodiments, each of the three strain gauges 302A, 302B, and 302C are substantially identical. In one or more embodiments, the strain gauges 302 can be considered to be substantially identical if they have similar specifications, such as, for example, a same gauge factor, where the gauge factor can be defined by a ratio of relative change in the resistance of a strain gauge to a level of mechanical strain applied to the strain gauge. In one or more other embodiments, the strain gauges 302 can have similar specifications and be manufactured by the same manufacturer to be considered substantially identical.

In one or more embodiments, the strain gauges 302 are not each substantially identical to the other strain gauges 302. For example, the strain gauges 302 may have different sensitivities by design.

In one or more embodiments, button press criteria can be established, which when met, can indicate that the corresponding button representation has been pressed. For example, with respect to the button area 304, button press criteria can include the criteria in Equation (1), where V_{A}, V_{B}, and V_{C} represent an amplitude of an associated electrical signal (e.g., voltage, peak voltage, root mean square voltage, or average voltage of a bridge circuit) corresponding to the strain gauges 302A, 302B, and 302C, respectively; and Vₜₕ corresponds to a threshold amplitude.

Criteria 1:V_{A}≈V_{B}≈V_{C}

Criteria 2: V_{A},V_{B},V_{C}>Vₜₕ (1)

Thus, the button representation corresponding to the button area 304 can be considered to be pressed by a user if amplitudes of the electrical signals V_{A}, V_{B}, and V_{C} corresponding to the three strain gauges 302A, 302B, and 302C are approximately equal (Criteria 1), and if the electrical signals V_{A}, V_{B}, and V_{C} are greater than a threshold amplitude Vₜₕ (Criteria 2). If both these criteria are not met, then the button representation corresponding to the button area 304 is not considered to have been pressed.

Criteria 1 seeks to ensure that user presses at or substantially near the center of the button area 304 are considered as a valid user input with respect to the button representation corresponding to the button area 304, whereas user presses away from the center of the button area 304 are considered as invalid user input with respect to the button representation corresponding to the button area 304. For example, if a user were to press at a location that is offset from the center of the button area 304 and nearer to the strain gauge 302A, then the amplitude of the electrical signal corresponding to the strain gauge 302A would be greater than that corresponding to the other two strain gauges 302B and 302C. Thus, the amplitudes of the electrical signals corresponding to the strain gauges would not be approximately equal, indicating an invalid user input with respect to the button representation corresponding to the button area 304. In one or more embodiments, amplitudes of electrical signals corresponding to the strain gauges are considered to be approximately equal if the amplitudes are within about 5%, about 10%, or about 15% of each other.

Criteria 2 seeks to ensure that user presses with an associated force that is greater than a threshold magnitude of force are considered as a valid user input with respect to the button representation corresponding to the button area 304, whereas a magnitude of force that is less than the threshold magnitude of force are considered as invalid user input with respect to the button representation corresponding to the button area 304, so that accidental and unintentional user presses at or near the button area 304 are ignored. The threshold Vₜₕ can be selected to correspond to the desired threshold magnitude of force. For example, in some embodiments, Vₜₕ can be experimentally determined by pressing the button area 304 with a series of presses of varying magnitude of force while measuring the corresponding amplitude of the electrical signals of one or more of the strain gauges 302. The value of Vₜₕ that corresponds to the desired threshold magnitude of force can then be selected as the amplitude threshold Vₜₕ. In one or more other embodiments, the value of the threshold force can be analytically determined based on mechanical properties of the substrate 306 (such as thickness, stiffness, etc.).

In some embodiments, a button press criteria can include one of the two criteria of equation (1) (Criteria 1 or Criteria 2) rather than both. For example, the pressing of the button area 304 can be considered as a valid user input if just Criteria 2 (V_{A}, V_{B}, and V_{C}>Vₜₕ) is met.

Equation (1) can be modified to include additional criteria. For example, the criteria of equation (1) could be augmented with an additional criteria that each strain gauge sensor 302A, 302B, 302C amplitude is within a percentage error of an average amplitude for the strain gauge sensors 302A, 302B, 302C, allowing for offset of the user press (e.g., extending outside of the button area 304 in one direction).

In some embodiments, fewer than, or more than, the three strain gauges 302A, 302B, 302C may be used. For example, two strain gauges 302 or four or more strain gauges may be used.

In one or more embodiments, the arrangement of strain gauges 302 in FIG. 3A represents a ring of strain gauges 302 positioned to surround the button area 304, to identify from electrical signals that a deformation has occurred at the ring of strain gauges 302 or outside the ring of strain gauges 302, thereby reducing a risk of an unintended substrate deformation being interpreted as a valid user input with respect to the button area 304. A touch sensor (not shown, e.g., another strain gauge 302) may be deployed within the ring of strain gauges 302.

FIG. 3B illustrates a plan view of an example arrangement 352 of strain gauges in a touch sensitive user interface. In particular, the example arrangement 352 includes the strain gauges 302A, 302B, 302C included in the example arrangement 300 shown in FIG. 3A, and also includes a center strain gauge 302D. The center strain gauge 302D is mounted on the same side of the substrate 306 on which the strain gauges 302A, 302B, 302C are mounted. However, the center strain gauge 302D is positioned to be at least partially within the button area 304. In particular, the center strain gauge 302D can be positioned such that a substantial portion of a surface area of the center strain gauge 302D coincides with the button area 304. In one or more embodiments, such as the one shown in FIG. 3B, the surface area of the center strain gauge 302D is completely confined within the button area 304. An angle formed by the longitudinal axis of the center strain gauge 302D with the longitudinal axes of the strain gauges 302 can be arbitrary. In one or more embodiments, such as the one shown in FIG. 3B, the longitudinal axis of the center strain gauge 302D is collinear with the longitudinal axis of the strain gauge 302C.

Button press criteria can be established for the button area 304 which takes into consideration measurements regarding the center strain gauge 302D in addition to the measurements regarding the strain gauges 302A, 302B, 302C. For example, criteria with respect to the center strain gauge 302D can include the criteria in Equation (2), where V_{D} represents the represent the amplitude of an electrical signal (e.g., voltage, peak voltage, root mean square voltage, or average voltage of a bridge circuit) corresponding to the center strain gauge 302D.

Criteria 3: V_{D}>V_{A},V_{B},V_{C}

Criteria 4: V_{D}>Vₜₕ₂ (2)

In an example, a button representation corresponding to the button area 304 is considered to be pressed by a user if both Criteria 3 and Criteria 4 are met. Thus, if the amplitude of the electrical signal corresponding to the center strain gauge 302D is greater than that of the other strain gauges 302A, 302B, and 302C (Criteria 3), and also greater than a threshold amplitude (Criteria 4), then the button representation corresponding to the button area 304 may be identified as having been pressed. It should be noted that the value of the threshold amplitude Vₜₕ₂ can be selected in a manner similar to that discussed above in relation to the threshold amplitude Vₜₕ for the example arrangement 300 shown in FIG. 3A. In one or more embodiments, the strain gauges 302A, 302B and 302C and the center strain gauge 302D can be substantially identical. In other embodiments, the center strain gauge 302D may be different from (not substantially identical to) the strain gauges 302A, 302B and 302C.

In one or more embodiments, the arrangement 352 shown in FIG. 3B can include two or more center strain gauges 302. That is, one or more strain gauges 302D in addition to the single strain gauge 302D illustrated in FIG. 3B can be included in relation to the button area 304. In one or more embodiments, the two or more center strain gauges 302D can each be oriented in a same direction or in different directions, and any of the two or more center strain gauges 302D may (or may not) be aligned with an orientation of one of the strain gauges 302A, 302B, 302C. In one or more embodiments, a valid user input can be registered if Criteria 3 and 4 are met for each of the two or more center strain gauges 302D. In one or more embodiments, a valid user input can be registered if Criteria 3 and 4 are met for a subset of the two or more center strain gauges 302D. In one or more embodiments, a valid user input can be registered if Criteria 3 and 4 are met for an average of the electrical signal amplitudes corresponding to all of, or a subset of, the two or more center strain gauges 302D.

In one or more embodiments, the voltages V_{A}, V_{B}, V_{C} in FIG. 3A, or the voltages V_{A}, V_{B}, V_{C}, and V_{D} in FIG. 3B, may represent amplified voltages corresponding to the voltages sensed at the respective strain gauges. Amplification may be different for ones of the voltages, such as to incorporate a weighting or scaling function to accommodate different environments of the associated strain gauges. For example, a stiff portion of the substrate 306 or a portion of the substrate 306 near a stiffening structure may not deform as much as another portion of the substrate 306, and a strain gauge 302 positioned near the stiff portion of the substrate 306 or near the stiffening structure may correspondingly experience less change of resistance than a strain gauge 302 elsewhere, and an associated output voltage may need to be amplified more than others.

It should be noted that arrangements of strain gauges other than the example arrangement 300 and the example arrangement 352 shown respectively in FIGS. 3A and 3B are within the scope of the present disclosure. For example, two strain gauges could be placed at diametrically opposite sides of the button area 304. Button press criteria could be similar to Criteria 1 and Criteria 2 described in Equation (1), except that amplitudes corresponding to two instead of three strain gauges is considered. In one or more embodiments, the button area 304 is located on a narrow beam (such as, for example, a door handle), and strain gauges can be arranged end to end (lengthwise) on a surface of the narrow beam opposing a surface over which button representations are provided.

In one or more embodiments, the example arrangement 300 shown in FIG. 3A or the example arrangement 352 shown in FIG. 3B can be modified such that the strain gauges 302A, 302B, 302C are arranged with their longitudinal axes oriented differently with respect to the center of the button area 304. For example, a strain gauge 302A, 302B, or 302C may be oriented with longitudinal axis tangential to a circumference of the button area 304, or oriented with longitudinal axis forming an angle with respect to a tangent of the circumference of the button area 304. In one or more embodiments, the strain gauges 302 can be arranged such that at least two strain gauges 302A, 302B, or 302C have their respective longitudinal axes perpendicular to each other.

In one or more embodiments, where material properties and/or dimensions of the substrate 306 are such that pressing on the surface of the substrate 306 results in deformation within a relatively small area that can be accommodated by a surface area of a single strain gauge, then a single strain gauge may be used. In one or more such implementations, button press criteria could, for example, be similar to Criteria 2 of Equation (1), where the button representation is considered to be pressed if a voltage corresponding to the single strain gauge is greater than a threshold amplitude Vₜₕ₃.

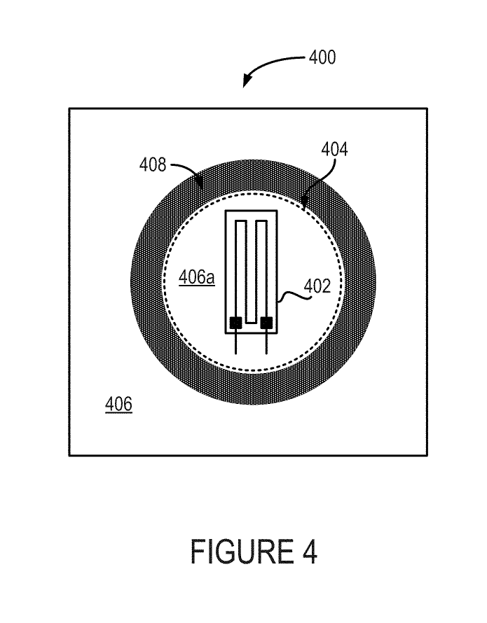

FIG. 4 illustrates a plan view of an example arrangement 400 of a strain gauge sensor that can be used in a touch sensitive user interface. In particular, the arrangement 400 includes a strain gauge 402 and an isolating ring 408 disposed on a substrate 406. The substrate 406 can be similar to the touch sensitive user interface 102 discussed above in relation to FIGS. 1A-1C, while the strain gauge 402 can be similar to the strain gauges 110 and 250 discussed above in relation to FIGS. 1B-2B. The strain gauge 402 and the isolating ring 408 are mounted on a rear side of the substrate 406 that is opposite to a front side from which a user interacts with the substrate 406, such as a user facing side on which button representations are provided. A boundary of a button area 404 corresponding to a button representation is shown in FIG. 4 with broken lines. In one or more embodiments, the isolating ring 408 is a substantially planar ring having an outer boundary and an inner boundary. In one or more other embodiments, the isolating ring can be a flange-like structure. The inner boundary of the isolating ring 408 defines an isolated substrate region 406a on the surface of the substrate 406 within which the strain gauge 402 is disposed. The strain gauge 402 can be oriented in any direction with respect to the isolating ring 408. In one or more embodiments, such as the one shown in FIG. 4, an entire sensing surface area of the strain gauge 402 is in contact with the isolated substrate region 406a. In one or more other embodiments, at least a portion of the sensing surface of the strain gauge 402 can be in contact with the isolated substrate region 406a. The button area 404 is substantially within the isolated substrate region 406a: an inner diameter of the isolating ring 408 is appropriately selected and the isolating ring 408 is appropriately positioned such that the button area 404 is substantially within the isolated substrate region 406a. In one or more other embodiments, the button area 404 can be larger than the isolated substrate region 406a.

The isolating ring 408 mechanically isolates the isolated substrate region 406a from forces acting elsewhere on the substrate 406. For example, if a user presses on the front surface of the substrate 406 at a location outside of the isolated substrate region 406a, the isolating ring 408 can substantially limit the resulting deformation of the substrate 406 so that deformation in the isolated substrate region 406a is minimized or prevented, or results in electrical signals from the strain gauge 402 that are interpreted according to associated criteria as invalid user presses. However, if the user were to press on the substrate 406 within the button area 404, the isolated substrate region 406a would be deformed, resulting in the deformation being sensed by the strain gauge 402 and potentially interpreted as a valid user input. In one or more embodiments, button press criteria can be established where the deformation of the strain gauge 402 can be considered to be a valid user input if an amplitude of the corresponding electrical signal (e.g., voltage, peak voltage, root mean square voltage, or average voltage of a bridge circuit) is greater than a threshold amplitude. In some embodiments, setting threshold criteria can be beneficial in practice where it may not be possible to completely mechanically isolate the isolated substrate region 406a from forces acting elsewhere on the substrate 406. Thus, even if forces acting on the substrate 406 outside of the button area 404 cause some amount of deformation of the isolated substrate region 406a, and therefore of the strain gauge 402, unless the deformation is large enough, the deformation will not be registered as a valid user input.

In one or more embodiments, a degree of isolation provided by the isolating ring 408 can be a function of a thickness of the isolating ring 408 as compared to a thickness of the substrate 406. In one or more such embodiments, the isolating ring 408 can have a thickness that is about twice to about five times the thickness of the substrate 406. In one or more embodiments, the degree of isolation also can be a function of the strength of an adhesion between the isolating ring 408 and the substrate 406. In one or more such embodiments, the isolating ring 408 can be adhered to the substrate 406 using an adhesive such as, but not limited to, epoxy or a metal adhesive (e.g., a Loctite brand adhesive, such as Loctite 324), that can create a strong bond. In one or more other such embodiments, the isolating ring 408 can be welded onto the surface of the substrate 406 to create a strong and long lasting bond.

In one or more embodiments, additional strain gauges 402 can be included within the isolated substrate region 406a such that there are two or more strain gauges 402 in the isolated substrate region 406a. In some such embodiments, electrical signals corresponding to the two or more strain gauges 402 positioned within the isolated substrate region 406a can be used to determine a valid user input. In one or more embodiments, user press criteria can be applied to the electrical signals received from the two or more strain gauges to determine a valid user input. In some such embodiments, deformation associated with the two or more user inputs can be considered a valid input if, for example, an amplitude of electrical signals corresponding to each of the strain gauges 402 is greater than a threshold amplitude. In some other embodiments, a valid user input can be established if the amplitude of electrical signals of a subset of all the strain gauges 402 within the isolated substrate region 406a is greater than a threshold amplitude. In some other embodiments, a valid user input can be established if the average of the amplitudes of electrical signals of all or a subset of the strain gauges 402 within the isolated substrate region 406a is greater than a threshold amplitude.

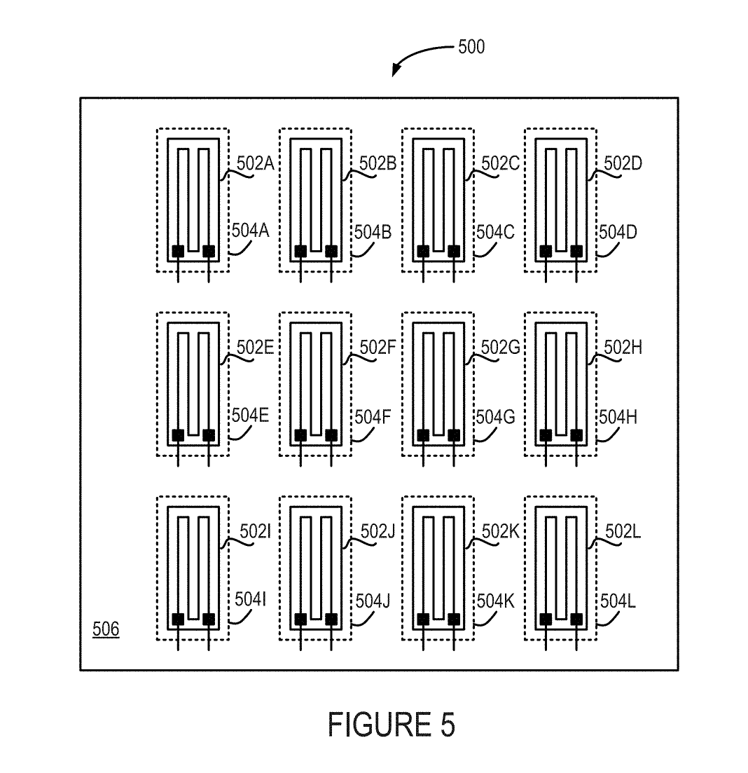

FIG. 5 shows a plan view of an example arrangement 500 of strain gauges for use in a touch sensitive user interface. In particular, FIG. 5 shows a grid of strain gauges including strain gauges 502A, 502B, 502C, 502D, 502E, 502F, 502G, 502H, 502I, 502J, 502K, and 502L (collectively referred to hereinafter as “the grid of strain gauges 502”) mounted on a substrate 506. The grid of strain gauges 502 corresponds to a grid of button areas. For example, a grid of button areas including button areas 504A, 504B, 504C, 504D, 504E, 504F, 504G, 504H, 504I, 504J, 504K, and 504L (collectively referred to hereinafter as “the grid of button areas 504”) are provided on the side of the substrate 506 opposite the side on which the grid of strain gauges 502 are disposed. In one or more embodiments, each button area in the grid of button areas 504 can correspond to a button representation such as a button representation 106 shown in FIGS. 1A and 1B. The grid of strain gauges 502 may be positioned and aligned such that each strain gauge in the grid of strain gauges 502 coincides with one button area of the grid of button areas 504. When a user presses on a button area in the grid of button areas 504, forces exerted on the button area cause deformation of the button area. The deformation of the button area can, in turn, cause deformation of the corresponding strain gauge.

With the example arrangement 500 shown in FIG. 5, when a user presses one button area, the resulting forces can result in the deformation of not only the strain gauge corresponding to that button area, but also surrounding strain gauges. For example, if the user presses on the button area 504A, the strain gauge 502A would be deformed. However, depending on the magnitude of the force exerted by the user and the physical characteristics of the substrate 506, the surrounding strain gauges 502B, 502E, and 502F may also be deformed. In some such situations, determining which of the button areas has been pressed while having multiple strain gauges indicating deformation can include use of button press criteria. In one or more embodiments, the button press criteria include determining a strain gauge with a greatest electrical signal amplitude, and determining whether the amplitude is greater than a threshold amplitude. For example, if the user presses the button area 504A, the strain gauge 502A would typically experience greater deformation than that experienced by the surrounding strain gauges 502B, 502E, and 502F, which are farther away from the button area 504A than is the strain gauge 502A. Thus, an amplitude of an electrical signal corresponding to the strain gauge 502A would be greater than an amplitude of an electrical signal corresponding to each of the surrounding strain gauges. This can indicate that the button area 504A corresponding to the strain gauge 502A has been pressed.

In some embodiments, the button areas in the grid of button areas 504 can have different shapes and sizes than shown in FIG. 5. For example, in some embodiments, the size of a button area can be smaller than a size of the corresponding strain gauge. In some other implementations, the shape of one or more of the button areas in the grid of button areas 504 can be substantially circular or otherwise elliptical, square or otherwise rectangular, other polygonal shape, or an irregular shape (e.g., arbitrary boundary, half moon, etc.).

In one or more embodiments, the grid of button areas 504 can be positioned with respect to the grid of strain gauges 502 such that each button area is associated with more than one strain gauge. For example, one button area can be positioned between the four strain gauges 502A, 502B, 502E and 502F. Other button areas can be positioned between another set of adjacent four strain gauges, or can overlap multiple adjacent strain gauges. In some such implementations, the determination of whether a button has been pressed by a user can be made using button press criteria such as one or more of the button press criteria discussed above (e.g., in relation to FIG. 3A or 3B). For example, for a button area corresponding to four adjacent strain gauges, when the amplitudes of electrical signals related to the four adjacent strain gauges are approximately equal and above a threshold value, a valid user input may be registered.

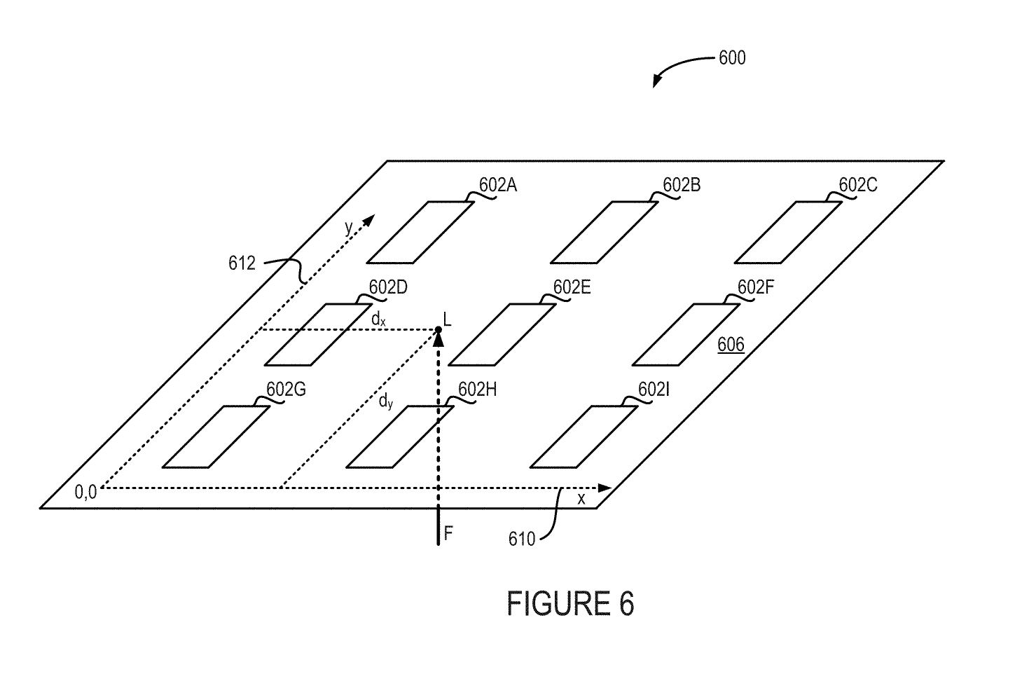

FIG. 6 depicts an example arrangement 600 of strain gauges for use in a touch sensitive user interface. In particular, the example arrangement 600 of strain gauges can be used to detect both a location on the substrate where the user has pressed and also a magnitude of force with which the user pressed at that location For example, a force within a certain range can correspond to a first input, while a force within a second range at the same location can correspond to another input. The location where the user pressed on the substrate can be compared to known locations of button representations on the front facing side of the substrate to determine which button representation the user is pressing.

The example arrangement 600 includes strain gauges 602A, 602B, 602C, 602D, 602E, 602F, 602G, 602H and 602I arranged in a grid (collectively referred to hereinafter as “the grid of strain gauges 602”) over a rear surface of a substrate 606. The grid of strain gauges 602 are arranged in a manner not unlike the grid of strain gauges 502 shown in FIG. 5. Each of the strain gauges in the grid of strain gauges in FIG. 6 can be similar to the strain gauge 110 or 250 discussed above in relation to FIGS. 1C and 2B, respectively. For sake of simplicity, only the outlines of the strain gauges are shown, and the locations of button areas are not shown. The substrate 606 can represent the touch sensitive user interface 102 discussed above in relation to FIGS. 1A and 1B, with the grid of strain gauges 602 mounted on the rear surface of the touch sensitive user interface 102.

The grid of strain gauges 602 is arranged within a reference frame defined by an x-axis 610 and a y-axis 612. A location (d_{y}, d_{y}) of each of the strain gauges within the reference frame can be specified in a data file stored in a memory, such as the memory 210 shown in FIG. 2A. In addition, a model of strain as a function of force and location in the reference frame can be generated. The model receives as input the electrical signals corresponding to one or more of the strain gauges in the grid of strain gauges 602 resulting from a user pressing on the substrate 606, and outputs an estimate of a location (dₓ, d_{y}) of the user press on the substrate 606 and the force F with which the user pressed on the substrate 606.

In one or more embodiments, the model can be generated using analytical models of the substrate 606. For example, based at least on the properties of the material of the substrate 606, the dimensions of the substrate 606, and the manner in which the substrate is mounted, an analytical model can be generated describing properties of the substrate 606 (e.g., equations relating force applied to deformation). In one or more embodiments, the above mentioned properties of the substrate 606 can be provided as an input to a finite element analysis tool (such as, without limitation, ANSYS or SolidWorks) to establish relationships between the force F applied at a location (dₓ, d_{y}) and strain measured at locations where strain gauges 602 are mounted on the substrate 606. Based on these relationships, the analytical model can receive as input strain gauge readings corresponding to a user press, and provide an estimate of the force F and the location (dₓ, d_{y}) of the user press on the substrate 606.

In one or more embodiments, the model can be experimentally generated. For example, a series of presses on the substrate 606 can be applied while varying both location (dₓ, d_{y}) and force (F). A value related to electrical signals corresponding to one or more strain gauges of the grid of strain gauges 602 for each of the series of presses can be recorded and stored. For example, in one or more embodiments, model generation can include (1) for particular values of F, dₓ, and d_{y}, determining a set of measured voltage amplitudes corresponding to each of the strain gauges in the grid of strain gauges 602 and storing the values in memory; (2) incrementally changing the value of F, while keeping the location (dₓ, d_{y}) constant, and for each incremental value of F determining and storing a set of measured voltage amplitudes corresponding to each of the strain gauges; and (3) repeating (2) at various locations on the substrate. Thus, in this example, if there are m different values of F, n different values of dₓ, and l different values of d_{y}, then the model can include m×n×1 sets of amplitudes of voltages corresponding to strain gauges, where each set includes voltages corresponding to each of the strain gauges in the grid of strain gauges 602 (a set of the amplitudes of voltages corresponding to strain gauges is referred to hereinafter as “a set of strain gauge voltage values”). In one or more embodiments, interpolation can be used to determine the sets of strain gauge voltage values corresponding to values of F, dₓ, and d_{y} that lie between the experimentally determined values. In one or more embodiments, a linear relationship can be assumed between the force F and the resulting strain gauge voltage values. Under this assumption, the process of experimentally generating the model can be substantially simplified by determining a set of strain gauge voltage values for a single magnitude of force at various locations (dₓ, d_{y}) on the substrate, and then determining additional sets (m−1) of strain gauge values corresponding to other values of force by multiplying the determined set of strain gauges values by appropriate multiplication factors. In this manner, a number of experimental samples to determine m×n×1 sets of strain gauge voltage values is n×1.

During operation, in response to a user pressing on the substrate 606, amplitudes of voltages corresponding to one or more strain gauges of the grid of strain gauges 602 can be compared to the model to determine the approximate location and force of the user press. In particular, amplitudes of the voltages corresponding to the grid of strain gauges 602 can be compared to the sets of strain gauge voltage values to determine the set of strain gauge voltage values that is a best match to the amplitudes of the voltages. Once the best matching set of strain gauge voltage values is found, the values of force F and location (dₓ, d_{y}) corresponding to the best matched set of strain gauge values can be used as an estimate for the force and the location of the user press. In one or more embodiments, the best matching set of strain gauge voltage values can be estimated using a minimum mean squared error estimator. Specifically, in one or more embodiments, a squared error, or residual R_{F,d}_{ₓ}_{,d}_{_{y}}, can be determined for each of the m×n×l sets of strain gauge voltage values, where the residual R_{F,d}_{ₓ}_{,d}_{_{y}} can be expressed by the following Equation (3), where \hat{V}_{i,F,d}_{ₓ}_{,d}_{_{y}} denotes the stored amplitude of the voltage corresponding to the i^{th} strain gauge of M strain gauges for given values of F, dₓ, and d_{y}; and Vᵢ denotes the measured amplitude of the voltage corresponding to the i^{th} strain gauge.

$${R}_{F , {d}_{x} , {d}_{y}} = {\sum }_{i}^{M} {( {\hat{V}}_{i , F , {d}_{x} , {d}_{y}} - {V}_{i} )}^{2} \qquad ( 3 )$$

Using Equation (3), m×n×l different residual values R_{F,d}_{ₓ}_{,d}_{_{y}} are determined. Out of the m×n×l different residual values R_{F,d}_{ₓ}_{,d}_{_{y}}, a minimum residual value is then determined. The values of F, dₓ, and d_{y} corresponding to the minimum residual value is selected as a best estimate for the value of the force F and the location (dₓ, d_{y}) where the user pressed on the substrate 606. In one or more embodiments, residual criteria can be defined in which a residual value should be below a certain residual threshold to be considered the minimum residual value. In one or more embodiments, estimators other than mean squared error (described above) can be used to determine an estimate for the value of the force magnitude F and the location where the user pressed on the substrate 606. For example, in one or more embodiments, estimators such as, without limitation, mean absolute error and mean absolute scaled error also can be used.

In one or more embodiments, the estimated location of the user press on the substrate 606 can be compared to known locations of button areas or button representations on the front surface of the substrate 606 to determine which button representation the user pressed. The combination of the identity of the button pressed by the user and the magnitude of the force with which the user pressed that button can be used to determine the user input.

In one or more embodiments, the techniques discussed above in relation to estimating the magnitude of force and location associated with a single user press can be used in determining the magnitude of force and location associated with each of multiple simultaneous user presses on the substrate 606. For example, in one or more embodiments, a model can be generated that includes n sets of strain gauge voltage values where each set of strain gauge voltage values corresponds to a single combination of magnitude of forces and their respective locations on the substrate 606. The n sets of strain gauge voltage values can, in some embodiments, include a set of strain gauge voltage values corresponding to each of n finite combinations of force magnitudes and their respective locations. For example, for a model representing two simultaneous user presses, the n sets of strain gauge voltage values can include a set of strain gauge voltage values corresponding to each of n different combinations of the magnitude of force of the first user press, the location of the first user press, the magnitude of force of the second user-press, and the location of the second user press. During operation, the measured strain gauges voltage values can be compared to each of the n sets of strain gauge voltage values to determine respective n residual values. The combination of the magnitude of the force of the first user-press, the location of the first user-press, the magnitude of force of the second user press, and the location of the second user-press that results in the smallest residual can be used as a best estimate of the magnitude of force and location of each of the two user-presses. The two estimated locations can be compared to known locations of button representations on the front surface of the substrate 606 to identify the two button representations the user pressed. The combination of the identity of the button representations pressed by the user and the magnitude of the force with which the user pressed each button representation can be used to identify an intended user input. Similar techniques can be used for three or more simultaneous user presses on the substrate 606. As mentioned above, in one or more embodiments, a linear relationship can be assumed between the force F and the resulting strain gauge voltage values. In some such embodiments, the number of experiments needed to determine the set of strain gauges voltage values corresponding to various magnitudes of forces can be reduced. For example, a set of strain gauge values for only a limited number of force magnitudes may be experimentally determined. Additional sets of strain gauge voltage values corresponding to other force magnitudes can be determined by linear summation of the experimentally determined sets of strain gauge voltage values.

In one or more embodiments, the user interface can include two or more types of sensors to determine both the location and the magnitude of force associated with each of a plurality of simultaneous user-presses. For example, a set of capacitive sensors can be used to determine locations of user presses, while the grid of strain gauges 602 can be used to determine the magnitude of force associated with each of the user presses. In one or more embodiments, the location sensors can be positioned on the surface of the substrate 606 facing the user. In one or more other embodiments, the location sensors can be positioned on the same surface of the substrate 606 on which the grid of strain gauges 602 is mounted. In either case, the number and locations of the location sensors can be the same as the number and locations of the strain gauges in the grid of strain gauges 602. The generation of the strain gauge model can include (1) determining a set of strain gauge voltage values for various values of forces at a single location (dₓ, d_{y}), (2) repeating (1) for various locations of on the substrate 606 where the location sensors are positioned. In this manner, the model would include m sets of strain gauges voltage values for each location of the location sensors. During operation, the locations of the user presses can be determined by the location sensors. Then, for each of the determined locations, an estimator can be used to compare the measured strain gauge values to the m sets of strain gauges values corresponding to that location to estimate the force applied at that location. In one or more embodiments, a mean squared error estimator can be used to determine a minimum residual of the mean squared error between the measured strain gauge values and the m sets of strain gauge values corresponding to that location. The value of the force corresponding to the minimum residual value can be used as the best estimate for the force applied at that location. In one or more embodiments, other estimators, such as, without limitation, mean absolute error and mean absolute scaled error also can be used. Thus, both the force and the location of the simultaneous user-presses can be determined.

In one or more embodiments, the location sensors can include capacitive sensors mounted on the substrate 606 to detect user presses. In some other embodiments, location sensors can include surface acoustic wave transmitters and receivers for determining the location of multiple user presses on the substrate 606. It is understood that other technologies for determining the location of the user presses on the substrate 606 also can be employed.

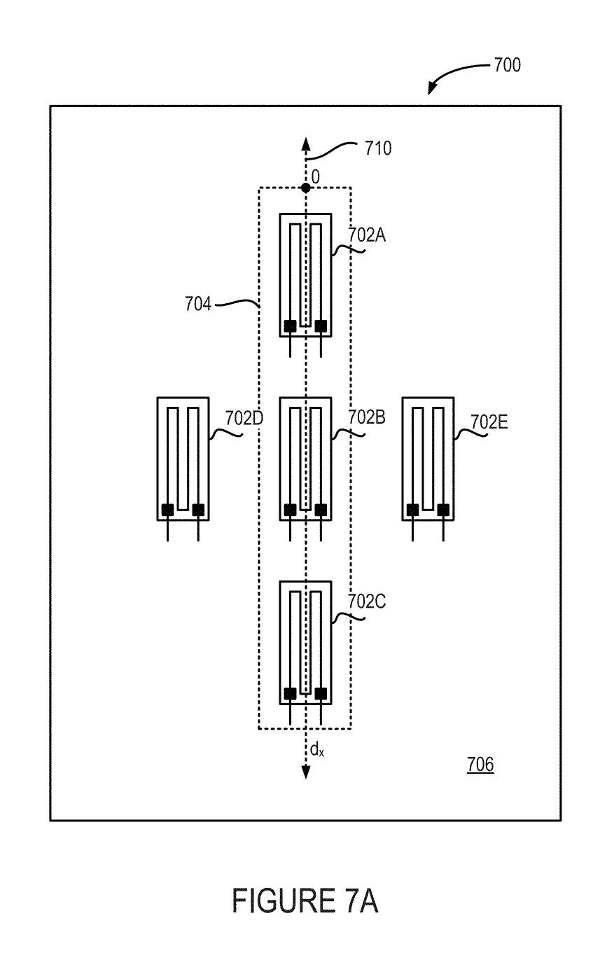

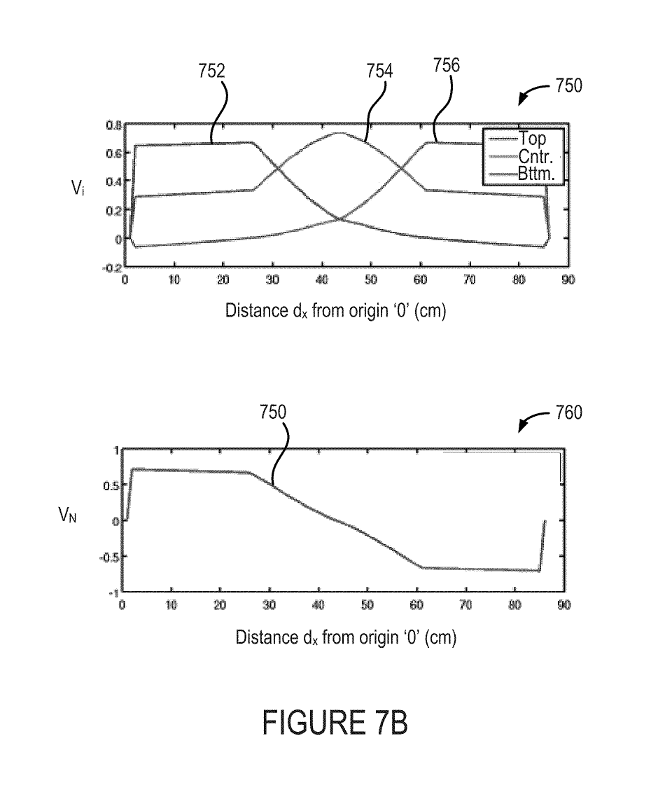

FIG. 7A depicts an example arrangement 700 of strain gauges for use in a touch sensitive user interface. In particular, the example arrangement 700 can be used to implement a force touch slider, in which a user can provide an input by sliding a finger over a button representation. The example arrangement 700 includes a top strain gauge 702A, a center strain gauge 702B, and a bottom strain gauge 702C (collectively referred to hereinafter as “the slider strain gauges 702”). The example arrangement 700 also includes a left strain gauge 702D and a right strain gauge 702E. The left strain gauge 702D and the right strain gauge 702E are positioned on either side of the center strain gauge 702B. The strain gauges 702 are mounted on a rear surface of a substrate 706. In one or more embodiments, the substrate 706 can represent the touch sensitive user interface 102 discussed above in relation to FIGS. 1A and 1B. The top strain gauge 702A, the center strain gauge 702B, and the bottom strain gauge 702C are distributed along a length of a button area 704 that corresponds to a slider button representation on a front facing side of the substrate 706. The button representation is substantially rectangular and defines an area over which a user can press and slide a finger either up or down in a direction denoted by the x-axis (also referred to hereinafter as a “center line”) 710. It is understood that the shape of the slider button representation can be elliptical, square, or other polygonal shape, or an irregular shape (e.g., arbitrary boundary, half moon, etc.) rather than rectangular. Accordingly, user input could be along a sequence of lines (e.g., without lifting the finger from the surface), along a circle, and so forth. In some embodiment, the button representation can define a range of levels for selection by the user. For example, the button representation can include markers that indicate levels such as 0 to 10, or 0 to 100, or 0 to 1, or other desired ranges. In this example, a user can press on the button representation corresponding to the button area 704 to indicate the desired level, or can slide a finger over a particular segment of the length of the button representation to indicate a desired increase or decrease in the level. For example, where the button representation indicates levels from 0 to 10, a user can slide the finger over half of a length of the button representation to indicate a desired increase or decrease in level of about 50%.

In one or more embodiments, a model of the strain gauges on the substrate 706 can be generated to aid in determining a magnitude of force and a location associated with a user press on the substrate 706. In one or more such embodiments, the model can be generated using analytical techniques that take into consideration a material and dimensions of the substrate 706, and the positions of the slider strain gauges 702, to provide an estimate of a magnitude of force and location of a user press based on measured strain on the slider strain gauges 702. In other embodiments, the model can be generated based on experimental data. For example, a series of presses on the substrate 706 can be applied while varying both location (dₓ, along the x-axis 710, in relation to origin ‘0’) and force (F). The amplitude of electrical signals (such as voltage signals) corresponding to one or more strain gauges 702 for each of the series of presses can be recorded and stored. For example, the model generation can include (1) for particular values of F and dₓ, determining a set of measured voltage amplitudes corresponding to each of the slider strain gauges 702, and storing the amplitudes in memory; (2) incrementally changing the value of F, while keeping the location, dₓ, constant, and for each incremental value of F, determining a set of measured voltage amplitudes corresponding to each of the strain gauges; and (3) repeating (2) at various locations along the center line 710 on the substrate 706. Thus, in this example, if there are m different values of F, and n different values of d, then the model can include m×n sets of strain gauge voltage values, where each set includes voltage values corresponding to the slider strain gauges 702. In one or more embodiments, one or more of the strain gauge voltage values in the m×n sets of strain gauge voltage values can be determined by interpolating other voltage values.

During operation, the model can be provided with the measured values of electrical signals associated with the strain gauges 702. The model can then output an estimate of the magnitude of the force and the beginning and end points of the user slide. Specifically, in one or more embodiments, a squared error or residual R_{F,d}_{ₓ} can be determined for each of the m×n sets of strain gauge voltage values using the following Equation (4), where \hat{V}_{i,F,d}_{ₓ} denotes the stored amplitude of voltage corresponding to the i^{th} strain gauge of M slider strain gauges for given values of F and dₓ; and Vᵢ denotes the measured amplitude of the voltage corresponding to the i^{th} strain gauge.

$${R}_{F , {d}_{x}} = {\sum }_{i}^{M} {( {\hat{V}}_{i , F , {d}_{x}} - {V}_{i} )}^{2} \qquad ( 4 )$$

Using Equation (4), m×n different residual values R_{F,d}_{ₓ} are determined. Out of the m×n different residual values, a minimum residual value is determined. The values of F and dₓ corresponding to the resulting minimum residual value are selected as a best estimate for the value of the force F and the location dₓ where the user pressed on the substrate 706. In one or more embodiments, a residual criteria can be defined which requires the minimum residual value to be below a certain residual threshold to be considered a minimum residual value. In one or more embodiments, button press criteria can be established, where the criteria is met if the amplitude of the voltage corresponding to the center strain gauge 702B is greater than the amplitude of the voltages corresponding to the left strain gauge 702D and the right strain gauge 702E. The criteria seeks to ensure that only those user presses that are substantially along the center line 710 are identified as valid user inputs with respect to the button representation corresponding to the button area 704. As mentioned above in relation to FIG. 6, estimators other than square error estimators also can be used to estimate the force F and the location dₓ where the user pressed on the substrate 706. in one or more embodiments, estimators such as, without limitation, mean absolute error and mean absolute scaled error also can be used.

In one or more embodiments, the controller can determine a direction in which the user press is sliding in relation to the button area 704. For example, in one or more embodiments, the controller can start a timer when the controller senses a first user press on the substrate 706 based on the voltages corresponding to the slider strain gauges 702 and the left and right strain gauges 702D and 702E. The controller also determines a magnitude of force F₁ and a location d₁ associated with the first user press by, for example, using Equation (4). In one or more such embodiments, the timer can be set to about 5 milliseconds (ms) to about 15 ms. Once the timer is complete, the controller again determines whether the user is pressing on the substrate 706 within the button representation corresponding to the button area 704. If the controller senses a second user-press, the controller re-starts the timer and determines a magnitude of force F₂ and a location d₂ associated with the detected second user press. The controller can continue to re-start the timer and determine a magnitude of force Fₛ and a location dₛ of detected user-presses. Once no additional (e.g., after expiration of the timer) user presses are detected, the controller determines the extent to which the user has moved the finger on the button representation corresponding to the button area 704 by determining a difference between the first recorded location d₁, and the final recoded location dₛ. In one or more embodiments, the value of the difference between d₁ and dₛ can indicate the extent and the direction in which the user slid the finger over the button representation, indicating a user intended change of a parameter associated with the button representation. In one or more embodiments, at a time of a start or an end of the timer, the controller can provide an audio, a visual, or an audio-visual feedback to the user on the current selected level, determined based on the magnitude of force and location associated with the last user-press, via a display, such as the display area 108 shown in FIG. 1B. The user can use the feedback to adjust the force and location of the finger on the button representation corresponding to the button area 704 until the desired level is displayed.

FIG. 7B illustrates graphical representations of examples of electrical signals associated with the strain gauges shown in FIG. 7A. Specifically, the first plot 750 shows voltage amplitude curves 752, 754, and 756 corresponding to the top 702A, center 702B, and bottom 702C strain gauges (shown in FIG. 7A), respectively, in response to a certain force F applied at various distances from the origin ‘0’ along the x-axis 710 (shown in FIG. 7A). Referring to the first plot 750, a force F applied near the origin ‘0’ of the x-axis 710 results in a voltage corresponding to the top strain gauge 702A that is relatively higher than that corresponding to the center strain gauge 702B and the bottom strain gauge 702C. A force applied at a point that is substantially over the center strain gauge 702B results in the amplitude of the voltage corresponding to the center strain gauge 702B being greater than the voltage corresponding to each of the top 702A and the bottom 702C strain gauges. At a point farthest from the origin ‘0’ along the x-axis 710, the force results in the amplitude of voltage corresponding to the bottom strain gauge 702C to be greater than the voltage corresponding to each of the top 702A and the center 702B strain gauges.

The second plot 760 plots the normalized voltage V_{N}=(V_{A}−V_{C})/(V_{A} V_{B} V_{C}), where V_{A}, V_{B}, and V_{C} represent voltages corresponding to the top 702A, center 702B, and the bottom 702C strain gauges respectively. The second plot 760 shows that the normalized voltage V_{N} is substantially linear over a certain range of distances from the origin ‘0’. Both the first plot 750 and the second plot 760 can be used to determine a position of a user press based on the amplitude of the voltage corresponding to each of the strain gauges or based on the normalized voltage. The data associated with the first plot 750 and the second plot 760 can be recorded and stored for various magnitudes of force.

In one or more embodiments of the present disclosure, time may be used in one or more criteria, such as a length of time that a threshold force is exceeded, a ramp time of force magnitude to the threshold force, a length of time that one or more criteria are satisfied, or a combination thereof.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A device comprising:
a substrate having a front surface and an opposing rear surface, the front surface including a button representation and the rear surface including a button area corresponding to the button representation;
a plurality of strain gauges mounted on the rear surface in proximity to the button area; and
a controller coupled to the plurality of strain gauges, the controller configured to:
receive information indicating multiple electrical signal amplitudes, each of the electrical signal amplitudes corresponding to one strain gauge of the plurality of strain gauges, each electrical signal amplitude representing an amount of deformation of the corresponding strain gauge; and
estimate a location of a pressure applied on the front surface of the substrate based on the received information.

2. The device of claim 1, the controller further configured to estimate a force applied at the location.

3. The device of claim 2, the controller further configured to identify, based on the estimated location, the estimated force, or the estimated location and the estimated force, a valid user input indicating a push of the button representation on the front surface of the substrate.

4. The device of claim 3, wherein the controller is configured to identify the valid user input in a circumstance in which the electrical signal amplitudes corresponding to the plurality of strain gauges are approximately equal.

5. The device of claim 3, wherein the controller is configured to identify the valid user input in a circumstance in which each of the electrical signal amplitudes is greater than a threshold amplitude.

6. The device of claim 1, further comprising at least one center strain gauge mounted on the rear surface of the substrate such that at least a portion of each of the at least one center strain gauge overlaps with the button area, wherein, for each of the at least one center strain gauge, the controller is configured to receive information regarding amplitude of an electrical signal corresponding to the center strain gauge, and the controller is further configured to identify a valid user input based on one or more of the electrical signal amplitudes corresponding to a respective one or more of the at least one center strain gauge.

7. The device of claim 6, wherein the controller is further configured to identify a valid user input based on one or more of the electrical signal amplitudes corresponding to a respective one or more of the at least one center strain gauge being greater than the electrical signal amplitudes corresponding to the plurality of strain gauges.

8. The device of claim 6, wherein the controller is further configured to identify a valid user input based on one or more of the electrical signal amplitudes corresponding to a respective one or more of the at least one center strain gauge being greater than a threshold amplitude.

9. The device of claim 6, wherein the at least one center strain gauge is positioned within a boundary of the button area.

10. The device of claim 1, wherein the substrate comprises stainless steel.

11. A device comprising:
a substrate having a front surface and an opposing rear surface, the front surface including a button representation and the rear surface including a button area corresponding to the button representation;
a ring mounted on the rear surface in proximity to the button area, an inner periphery of the ring defining an isolated area on the rear surface;
at least one strain gauge mounted on the isolated area on the rear surface; and
a controller coupled to the at least one strain gauge, configured to:
receive information indicating an amplitude of an electrical signal corresponding to the at least one strain gauge, and
identify a valid user input based on the received information.

12. The device of claim 11, wherein the controller is configured to identify a valid user input when the amplitude of the electrical signal corresponding to the at least one strain gauge is greater than a threshold amplitude.

13. The device of claim 11, wherein a thickness of the ring is about 2 to about 5 times a thickness of the substrate.

14. A device comprising:
a substrate having a front surface and an opposing rear surface, the front surface including one or more button representations;
a strain gauge mounted on the rear surface;
a controller coupled to the strain gauge, configured to:
receive information representing an amplitude value, the amplitude value representing an amplitude of an electrical signal associated with the strain gauge;
estimate a location of a pressure on the front surface of the substrate based on the received information.

15. The device of claim 14, wherein the amplitude value is a first value, further comprising an arrangement of strain gauges including the strain gauge, wherein the controller is further configured to receive information representing a plurality of amplitude values including the first value, each amplitude value representing an amplitude of an electrical signal associated with a respective strain gauge of the arrangement of strain gauges.

16. The device of claim 15, wherein the controller is further configured to estimate a location of a pressure on the front surface of the substrate based on the received information representing the plurality of amplitude values.

17. The device of claim 16, wherein the controller is further configured to estimate a force magnitude of a pressure on the front surface of the substrate based on the received information representing the plurality of amplitude values.

18. The device of claim 17, wherein the controller is configured to estimate the force magnitude and the location of the pressure by processing the received information using a model.

19. The device of claim 18, wherein the model is based on analytical models of the substrate and the strain gauges.

20. The device of claim 18,
wherein the model includes a plurality of predefined sets, each set corresponding to a different combination of predefined values of force magnitude, location on the front surface of the substrate, and multiple amplitude values; and
wherein the controller is configured to:
compare the plurality of amplitude values associated with the arrangement of strain gauges to the plurality of predefined sets, and
identify in the plurality of predefined sets a predefined set that results in a best match to the plurality of amplitude values associated with the arrangement of strain gauges, and
use the force magnitude and location on the front surface of the substrate corresponding to the predefined set resulting in a best match as an estimate for an actual force magnitude and an actual location of the pressure on the front surface of the substrate.

21. The device of claim 20, wherein the controller is further configured to:
compare the plurality of amplitude values associated with the arrangement of strain gauges with the plurality of predefined sets by determining a plurality of squared error residuals, each squared error residual being between the predefined multiple amplitude values of each set of the plurality of predefined sets and the plurality of amplitude values associated with the arrangement of strain gauges; determine a minimum squared error residual from the plurality of squared error residuals, and
identify in the plurality of predefined sets a predefined set that results in a best match to the plurality of amplitude values associated with the arrangement of strain gauges by identifying in the plurality of predefined sets a predefined set associated with the minimum squared error residual.

22. The device of claim 20, wherein the controller is further configured to determine an intended user input based on the identified predefined set.

23. The device of claim 15, wherein the pressure on the front surface of the substrate is a first pressure, and wherein the controller is further configured to determine a force magnitude and a location on the surface of the substrate associated with a second pressure on the front surface of the substrate, the second pressure occurring substantially concurrently with the first pressure.

24. The device of claim 15, wherein the arrangement of strain gauges mounted on the rear surface of the substrate corresponds to a slider button representation on the front surface of the substrate, and wherein the controller is further configured to receive information representing a sequence of amplitudes for electrical signals associated with each of the strain gauges in the arrangement of strain gauges, and identify an intended user input based on the sequences of amplitudes.

25. A device comprising:
a substrate having a front surface and an opposing rear surface, the front surface including a plurality of button representations;
an arrangement of strain gauges mounted on the rear surface;
an arrangement of location sensors mounted on the substrate; and
a controller coupled to the arrangement of strain gauges and the arrangement of location sensors, configured to:
receive first information representing a first plurality of amplitude values, each amplitude value representing an amplitude of an electrical signal associated with a strain gauge of the arrangement of strain gauges,
receive second information representing a second plurality of amplitude values, each amplitude value representing an amplitude of an electrical signal associated with a location sensor of the arrangement of location sensors,
estimate locations of a plurality of pressures applied to the front surface of the substrate based on the received second information, and
estimate force magnitudes of the plurality of pressures at the estimated locations based on the received first information.

26. The device of claim 25, wherein a number of the arrangement of location sensors on the substrate is same as a number of the arrangement of strain gauges.

27. The device of claim 25, wherein the arrangement of location sensors are mounted on the front surface of the substrate, and wherein a location of each of the arrangement of location sensors on the front surface coincides with a location of a corresponding strain gauge mounted on the rear surface of the substrate.

28. The device of claim 25, wherein the arrangement of location sensors includes capacitive sensors.

29. The device of claim 25, wherein the controller is further configured to estimate force magnitudes of the plurality of pressures at the estimated locations by processing the received first information using a model.

30. The device of claim 29, wherein the model is based on an analytical model of the substrate and the arrangement of strain gauges.

31. The device of claim 29, wherein the model includes a plurality of predefined sets, each set corresponding to a different combination of locations the arrangement of location sensors on the substrate and predefined values of force magnitude, each predetermined set including multiple amplitude values; and
wherein the controller is further configured to, for each location of the estimated locations:
compare the second plurality of amplitude values to the plurality of predefined sets corresponding to that location,
identify in the plurality of predefined sets a predefined set that results in a best match to the second plurality of amplitude values, and
use the predefined force magnitude corresponding to the identified predefined set that results in a best match as an estimate for a force magnitude at that location.
